(19) United States
(12) Patent Application Publication
(10) Pub. No.: US 2015/0154670 A1
(43) Pub. Date: Jun. 4, 2015

(54) Online Optimization and Fair Costing for Dynamic Data Sharing in a Cloud Data Market

(71) Applicant: NEC LABORATORIES AMERICA, INC., Princeton, NJ (US)

(72) Inventors: Ziyang Liu, Santa Clara, CA (US); Vahit Hacigumus, San Jose, CA (US)

(73) Assignee: NEC LABORATORIES AMERICA, INC., Princeton, NJ (US)

(21) Appl. No.: 14/506,626

(22) Filed: Oct. 4, 2014

Related U.S. Application Data
(60) Provisional application No. 61/911,613, filed on Dec. 4, 2013.

(51) Int. Cl. G06Q 30/06; G06Q 30/02

(52) U.S. Cl. CPC G06Q 30/0601; G06Q 30/0206

(57) ABSTRACT

A system for fair costing of dynamic data sharing in a cloud market is disclosed. The system uses an online method for sharing plan selection, as well as a set of fair costing criteria and a method that maximizes fairness.

This application claims priority to Provisional Application 61/911,613 filed Dec. 4, 2013, the content of which is incorporated by reference.

### BACKGROUND

In the big data era, data has become an integral part of decision making and user experience enhancement. An important observation is that organizations not only use internal data but also find compelling ways of integrating external data (such as publicly available data sets, surveys, curated data from other organizations, etc.) into their decision making and planning processes. As a result, several data markets have emerged, where the data can be sold and bought (e.g., Microsoft Azure Marketplace, Infochimps, Xignite, Gnip, among others), or in some cases data are freely shared with the public in the cloud. These data markets address many organizations' need to find more useful external data sets for deeper insights.

These recently emerged data markets are limited in functionality in two aspects. First, they either sell a whole data set or some fixed views of a data set, but do not allow arbitrary ad-hoc queries. This limitation leads to buyers needing to browse a large set of pre-defined views and possibly buying more data than they need. Second, current data markets only sell static data sets, e.g., GDP per state from 1997 to 2011. This limits the sale of many useful data sets that receive frequent updates. For example, a food retailer may be interested in purchasing users' check-ins at restaurants, tweets, etc., in order to infer a user's food preference and recommend corresponding products; a hotel booking service may be interested in purchasing users' flight booking data and calendar data in order to recommend hotels and design targeted promotions; a deal service may find helpful to purchase users' location data in order to alert the users of good deals near them. The data to be purchased in all these scenarios are dynamic and frequently updated. Existing data markets have two main limitations. First, they either sell a whole data set or some fixed views, but do not allow arbitrary ad-hoc queries. Second, they only sell static data, but not data that are frequently updated. While there exist proposed solutions for selling ad-hoc queries, it is an open question what mechanism should be used to sell ad-hoc queries on dynamic data.

These problems are challenging since different sharings with the same operations/subexpressions in their plans may reuse these operations, and each sharing plan must be generated online. Further, because sharing plans interact with each other, it is not trivial to find a fair cost for each sharing to impact the fairness of a costing function and a straightforward conventional mechanism will not work and existing solutions do not solve this problem. Some conventional systems aim to determine the price of a product (such as data) assuming the cost of the product can be easily obtained. On the other hand, our system focuses on the problem of determining the cost of a product (i.e., data sharing). Although conventional systems also have a concept of fairness, it is simply achieved by charging each user/query the same price to use the same product. In our costing problem many sharing plans interact in the global plan by reusing the same operations. It is further complicated by the fact that each sharing has multiple possible plans, and a plan may need to be considered even if it is not used.

### SUMMARY

A system for fair costing of dynamic data sharing in a cloud market is disclosed. The system uses an online method for sharing plan selection, as well as a set of fair costing criteria and a method that maximizes fairness.

Implementations of the system may include one or more of the following. The system uses data market framework that enables the sale/sharing of dynamic data, where each sale/sharing is specified by an ad-hoc query. To keep the shared data up-to-date, the service provider creates a view of the shared data and maintains the view for the data buyer.

Advantages of the system may include one or more of the following. The fairness criteria provides the basis for assessing the quality of a costing method, and the proposed costing Method ensures that the fairness is maximized over all possible costing methods. The system efficiently maintains the views, and fairly determines the cost each sharing incurs for its view to be created and maintained by the service provider.

### BRIEF DESCRIPTION OF THE DRAWINGS

FIG. 1 shows the sharing of plans for two consumers.

FIG. 2 shows a possible plan for joining relation A on server 1 and relation B on server 2.

FIG. 3 shows an exemplary process for Fair Costing for Dynamic Data Sharing in a Cloud Data Market.

FIG. 4 shows an exemplary computer.

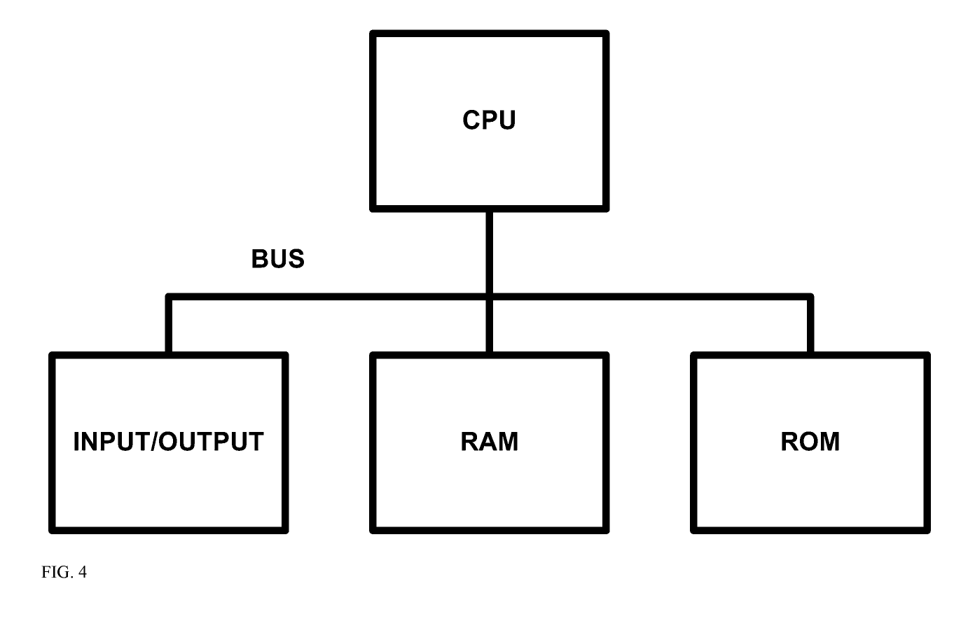

### DESCRIPTION

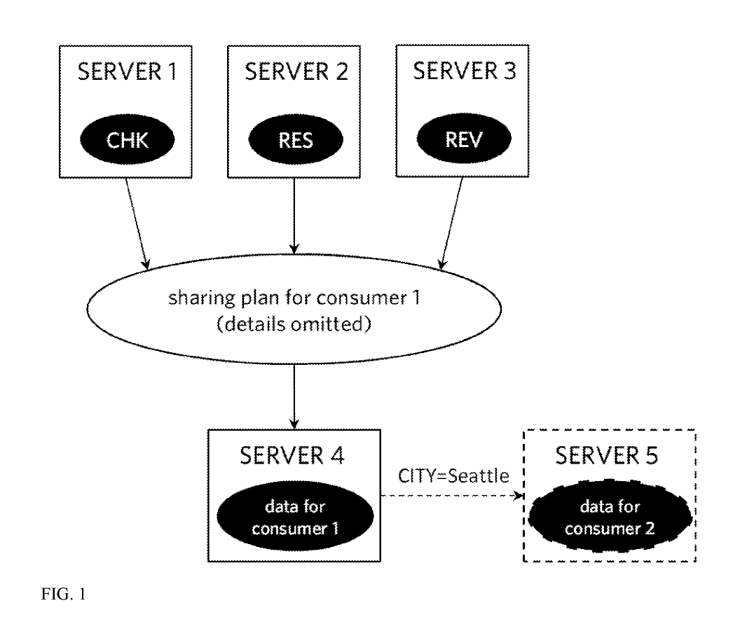

FIG. 1 shows an exemplary environment to sell dynamic data in a data market. The data market has three roles: data owner, data buyer, and data market service provider. The same person or organization may be both an owner and a buyer. The data owner is willing to sell/share the data with a price. Although the data owner may choose to sell the data directly to the data buyer, this direct sell would require significant amount of automation, as well as infrastructure efforts. Hence, the data seller prefers to go through the data market and leverage the services it offers, which is a common practice in cloud computing. As the data owners benefit from the services provided by the data market, the provider also benefits from serving a multitude of data owners and data buyers by consolidating them to achieve economies of scale. FIG. 1 shows the sharing plans for two buyers. Source data are located on servers 1-2, and the purchased data (view) are located on server 3 (for buyer 1) and server 4 (for buyer 2).

When a buyer specifies the data sets she's willing to buy, the service provider has two tasks: (1) deliver and maintain the data in a way that minimizes the operational cost (analogous to finding a query plan with minimum cost), and (2) calculate the price of the data, which should be a function of the monetary value of the data specified by the owner, and the operational cost. For problem (2), one embodiment focuses on calculating the operational cost. The monetary value of the data is assumed to be given by the data owner.

We use the dynamic data sharing term to refer to the sale of such dynamic data sets. A sharing plan specifies the set of operations/subexpressions to prepare the data for the buyer (such as the order of joins among the requested tables, time to apply predicates, time to move data between servers, etc.), which is analogous to a query plan for a SQL query.

### Example 1

Consider three data sets in the data market in the form of relational tables: check-in at restaurants (CHK), restaurant information (RES), and restaurant reviews (REV). A data buyer (buyer 1) is interested in a dynamic data sharing that joins these three tables. These tables may be owned by different data owners and reside in different physical servers in the cloud infrastructure. It is not trivial to design a plan with minimum cost that delivers and maintains the data requested by buyer 1, which involves the order of join, the way to move data between the servers, etc.; each of these operations may incur a dollar cost for the service provider, especially if the service provider rents infrastructures from an IaaS provider. Furthermore, if there's an existing data sharing that maintains the join of CHK and RES, it should be taken into account when designing the plan for the new sharing, since the data of the existing sharing (CHK [symbol] RES) may be reused.

Suppose we've selected a plan for this data sharing, as shown in solid lines in FIG. 1 with details omitted. Later another buyer (buyer 2) is also interested in a dynamic data sharing that joins CHK, RES and REV, but she is only interested in restaurants in Seattle. The service provider decides that the best plan for this buyer is to reuse the previous plan, and add a filter “city=Seattle” in the end, as shown in the dotted part in FIG. 1. Now suppose that the operational cost of maintaining these two sharings is $200/month. Then, what is the operational cost of each sharing? If we use a trivial approach that evenly divides the cost of each operation/subexpression among the sharings using the subexpression, the second sharing will be considered more costly than the first, since the second sharing plan has an additional step, “city=Seattle”. Consequently, buyer 2 may pay a higher price than buyer 1. However, this is not fair to buyer 2 because if buyer 1 did not exist, the second sharing plan may apply the predicate “city=Seattle” earlier, which may make the RES table much smaller and the sharing plan much cheaper.

For selecting sharing plans, we use an online Method. The Method should be online since it needs to service a sharing request as soon as it is received without knowing future requests. Our Method makes a significant improvement upon existing systems, which uses a greedy online Method (referred to as Method Greedy). Method Greedy enumerates the plans for the new sharing and chooses the plan that incurs the smallest additional dollar cost after integrating into the plans for existing sharings (referred to as global plan). We show that Method Greedy can perform arbitrarily badly even for very simple instances of the problem. We also analyze another baseline Method named Method Normalize, which normalizes the cost of a subexpression using the number of prior occurrences of the subexpression, and show that it can also perform arbitrarily badly. In contrast, our proposed Method, named Method ManagedRisk, judiciously chooses the plan for each sharing such that it neither avoids taking risks nor takes too much risks, which avoids making arbitrarily bad decisions for those instances where the baseline Methods fail.

For costing sharing plans, we use a set of fairness criteria for costing data sharings that consists of five conditions in one embodiment. These five conditions capture the degree of fairness, which is represented as a value between 0 and 1. The five conditions are non-redundant since it is possible to meet any four conditions but not the remaining one. We further present the necessary and sufficient condition of their satisfiability, and present an Method, named Method FairCost, that maximizes the degree of fairness.

A data market is a cloud computing infrastructure where tenants pay to use computing resources to run their applications and have the opportunity to sell data to one another through data sharings. Since tenants' applications keep collecting new data (e.g., the CHK table in FIG. 1 keeps collecting new check-in information), the data sold in the data market are dynamic. This is in contrast to the type of data markets like Microsoft Azure Marketplace, Infochimps, etc., where static data sets are sold.

A data owner willing to sell a data set makes the data set accessible to the service provider. In one embodiment we use data in the form of relational tables, but other forms can also be used. A buyer willing to purchase data may submit a data sharing request to the service provider in the form of a query, where a buyer wants to purchase the join of CHK, RES and REV. To service the request, the service provider is responsible for creating and maintaining the view specified in the query, which incurs dollar costs for using resources such as storage, CPU, network, etc., if the service provider rents resources from an IaaS provider such as AWS. As explained before, the price of a data sharing is a function of the data price specified by the data owner, as well as the operational cost incurred to deliver and maintain the data for the buyer.

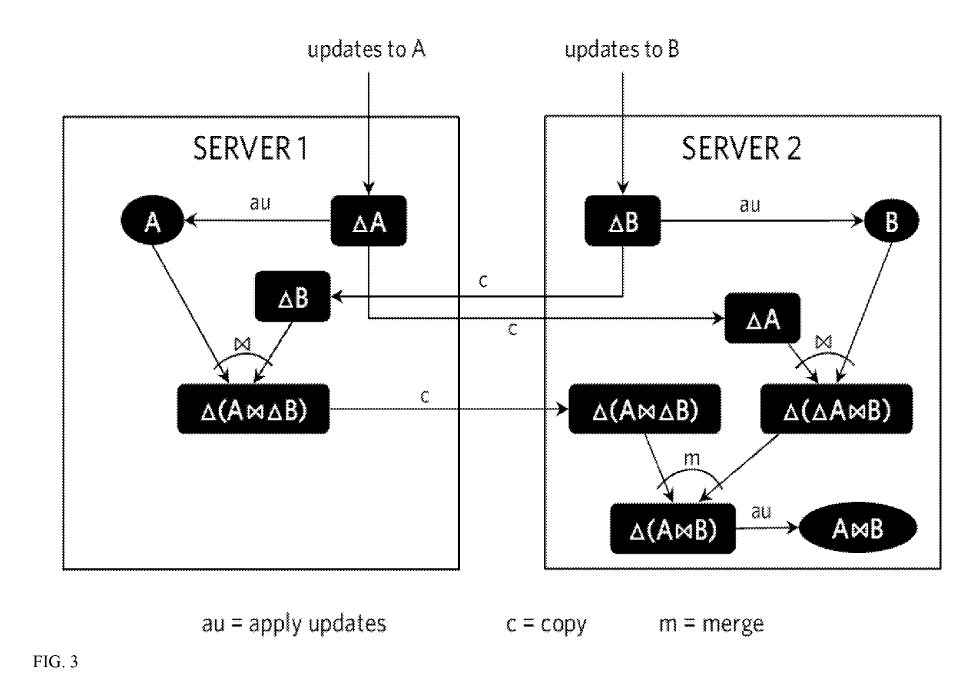

FIG. 3 shows a possible plan for joining relation A on server 1 and relation B on server 2 such that the resulting view A [symbol] B is placed on server 2 to arrive at a sharing plan. The plan determines how data should be moved among the servers, in which order the joins and predicates should be performed, etc., in order to maintain the shared data. Each join in the sharing plan can be specified as

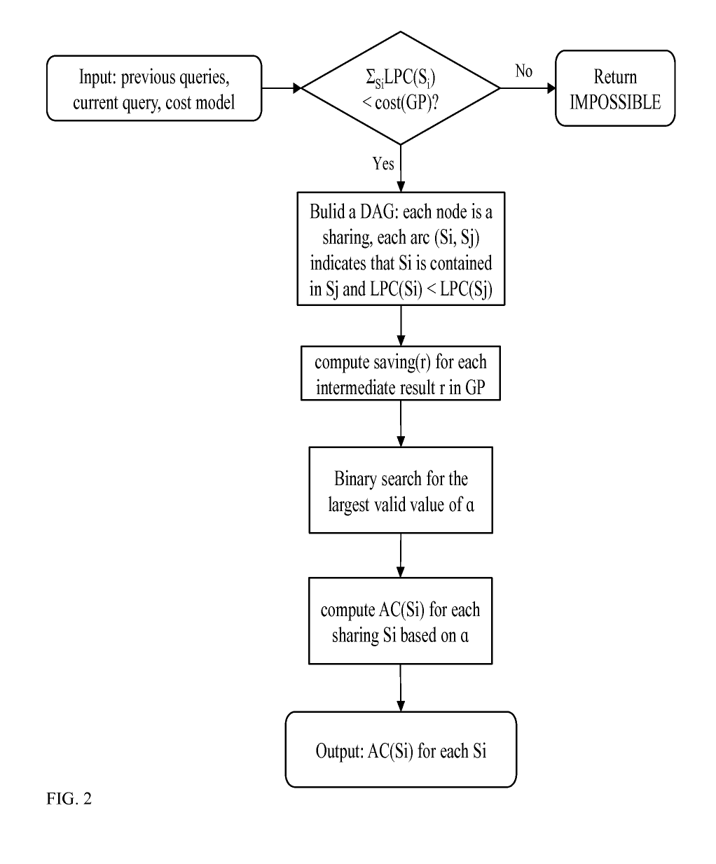

(A,s₁) [symbol] (B,s₂)→s₃

where s₁, s₂ are the servers that have a copy of A and B, respectively, which may be frequently updated, and s₃ is where the result should be placed. A possible plan for this join where s₁=server 1 and s₂, s₃=server 2 is shown in FIG. 2, where an ellipse denotes a base relation and a rounded rectangle denotes a delta relation, which receives updates to the corresponding base relation. Note that this plan avoids copying base relations across servers, and only copies delta relations.

For multiple sharings with common subexpressions, such as the two sharings in Example 1.1, the computation of a common subexpression can be reused so that the subexpression is only computed once. A plan involving multiple sharings is called a global plan. Next we introduce the costing of sharing plans in the global plan.

We assume that the data market service provider has a cost model for estimating the dollar cost of each subexpression, e.g., copy, merge, join, etc. To obtain the cost model, there exist analytical models to estimate resource usages for various operations in the cloud [20], and the resource usages can be directly mapped to dollar cost in cloud services such as AWS. Thus the service provider can calculate the cost per time unit of an individual sharing plan, which is the sum of the cost of each subexpression in the plan, multiplied by the number of times they are executed per time unit. However, this is not sufficient, as the service provider needs to determine the cost incurred by each sharing plan in the global plan in order to calculate the price of each sharing. This is complicated since different sharing plans in the global plan may reuse common subexpressions, and as said before, simply dividing the cost of each subexpression by the number of sharing plans that use it isn't fair.

Suppose the cost of the global plan is cost(GP) and there are n sharing plans P₁, . . . , Pₙ where the cost attributed to Pᵢ (referred to as “attributed cost”) is AC(Pᵢ), then the total cost of these sharing plans should equal the cost of the global plan, i.e.,

$${\sum }_{i = 1}^{n} A C ( {P}_{i} ) = cost ( GP )$$

and cost(GP) should be distributed to each AC(Pᵢ) in a fair way. Next we will further discuss the criteria of fairness and how to achieve maximum fairness.

As discussed before, the service provider needs to select a sharing plan for each new sharing without knowing future sharings. Thus the Method needs to be online We define the following online sharing plan selection problem.

Definition 1 (Online Sharing Plan Selection) The input contains a sequence of dynamic data sharings, a cost model and the initial state of the system. The service provider should select a sharing plan for each sharing without knowing future sharings. The goal of the service provider is to minimize the total cost of servicing the sequence of sharings.

The cost model is used to calculate the cost of each subexpression in a sharing plan, and the initial state of the system refers to the initial placement of data, i.e., which table is on which servers, and the server capacity constraint, which can be expressed in multiple ways such as how many tuples the server can handle per second.

For ease of illustration and explanation, we first consider a special case of the problem, where servers have unlimited capacity, and each sharing is a join-only query with no predicates or projections. We will discuss the general case in Section 4.5. Note that servers having unlimited capacity doesn't mean that all sharings are maintained on a single server, since different source data may be stored on different servers.

In the following, we denote a sharing as a set of source tables. For example, let a, b, c denote three tables. A sharing that joins these three tables is denoted as (a,b,c). A subexpression (i.e., join) is denoted by two sets of tables, e.g., ab is the join of a and b, and a(bc) is the join of a with b [symbol] c. A sharing plan is denoted by a sequence of joins, e.g., a(bc) is the plan where we first join b with c, and then join the result with a. Note that notation a(bc) may refer to both a subexpression and a sharing plan, but it is not a problem when the context is clear.

We use C[•] to denote the cost of a sharing plan and c[•] to denote the cost of a subexpression. For example, C[a(bc)] is the cost of the aforementioned sharing plan, and c[a(bc)] denotes the cost of joining a with b [symbol] c. Thus C[a(bc)]=c[bc]+c[a(bc)]. Let # join(S) be the number of joins in a plan of sharing S. For example, the value of # join for sharing (a,b,c) is 2, and all plans for this sharing have 2 joins.

Next, we discuss two baseline Methods, namely Method Greedy and Method Normalize, before presenting our proposed Method ManagedRisk. Both baseline Methods adopt the idea of hill-climbing, which is seen in the Methods of many classic problems including index/view selection. It refers to the attempt to add a good plan of the new sharing to the global plan. Method Greedy prefers a plan that adds the smallest cost to the global plan, while Method Normalize considers the subexpressions occurred in the existing sharings and assumes that they will occur again in future, and thus it chooses a plan with this assumption in mind. At a high level, for each sharing, all three Methods enumerate all possible plans, but use different criteria to decide which plan to use.

Note that in most cases we can afford to enumerate all possible plans, since choosing sharing plans is not an interactive or time-critical task. In case the sharing involves a complex query for which enumerating all plans is infeasible, we can use various heuristics, such as hill climbing and beam search, to generate a manageable subset of all possible plans.

Method Greedy enumerates all possible plans for a sharing, and chooses the one with the minimum additional cost after adding it to the global plan. The following example shows how Method Greedy works and why it may perform poorly, even if each sharing has at most two joins.

Example 2 Suppose there is a single server, and all sharings are processed within this server. Consider a sequence of sharings (a,b,c₁), (a,b,c₂), . . . . Suppose there are two possible plans for each sharing: (ab)cₓ and a(bcₓ), such that c[ab]=100, c[(ab)cₓ]=ε where ε is a negligibly small positive number, and C[a(bcₓ)]=10. If there are sufficiently many such sharings (more than 10), an optimal Method will use plan (ab)c₁ for the first sharing, so that all other sharings can reuse the result of ab and will only cost ε each. Suppose there are n sharings, the total optimal cost is 100+nε. Method Greedy, on the other hand, will always use plan a(bcₓ) for each sharing, and has a total cost of 10n, which is unbounded compared to the optimal cost.

As we can see, Method Greedy does not take any risk (here “risk” refers to using plan (ab)cₓ, since we do not know whether there will be future sharings to amortize the cost of ab, c[ab]). At the first glance, this seems what an Method should do, since it does not know the future and there is no incentive to take the risk and use plan (ab)cₓ. However, we will show in Section 4.4 that this is not necessarily true.

An attempt to solve the weakness of Method Greedy can lead to another baseline Method, which we name Method Normalize. To explain it, we introduce the following definition.

Definition 4.2 A sharing S is said to contain a subexpression s, denoted as s [symbol] S, if the subexpression occurs in one of the possible plans for the sharing.

For example, a sharing (a, b, c, d) may contain subexpressions ab, be, cd, ac, (ab)c, a(bcd), (ab)(cd), etc. (depending on joinability between tables), each of which denotes a join.

Method Normalize normalizes the cost of each subexpression in the current sharing by the number of sharings seen so far that contain this subexpression. Let Cₙ and cₙ denote the normalized cost of a sharing plan and a subexpression, respectively. Method Normalize selects the plan with the smallest normalized cost. For the sharing sequence in Example 4.1, when Normalize processes the x th sharing, if the first x−1 sharings all use plan a(bcₓ), then cₙ[ab] in the x th sharing is considered to be its original cost (100) divided by x, because ab is contained in all x sharings seen so far.

In this way, Normalize will use a(bcₓ) for the first 10 sharings, and for the 11th sharing, cₙ[ab] is 100/11, so Cₙ[(ab)c₁₁]<Cₙ[a(bc₁₁)] and Normalize will use plan (ab)c₁₁. In other words, although Normalize makes the wrong choices for the first 10 sharings, it eventually realizes that subexpression ab has occurred many times and decides to use ab even though it adds more cost to the global plan than the other option. Although it doesn't give the optimal solution, its cost is bounded in this particular example compared with the optimal solution.

Although Normalize works better than Greedy for Example 4.1, it may still have an unbounded cost even if each sharing has at most two joins, as shown in the following example.

Example 4.2 Consider a sequence of n sharings (a,b,c₁), (a,b,c₂), . . . , (a,b,cₙ). Again, suppose there are two possible plans for each sharing: (ab)cₓ and a(bcₓ). c[ab]=n. For 1≦x≦n−1, C[a(bcₓ)]=ε and c[(ab)cₓ]=ε. For the nth sharing, C[a(bcₙ)]=1+2ε and c[(ab)cₙ]=ε.

For this sharing sequence, Normalize will choose a(bcₓ) for the first n−1 sharings, incurring a cost of (n−1)ε. For the last sharing, cₙ[ab]=1 (since it is contained in all n sharings), thus Cₙ[(ab)cₙ]=1+ε<Cₙ[a(bcₙ)]=1+2ε, and Normalize uses plan (ab)cₙ. The total cost of Normalize is n+nε. An optimal Method would choose plan a(bcₓ) for all sharings for a total cost of 1+(n+1)ε. Since n can be arbitrarily large and ε can be arbitrarily small, Method Normalize has an unbounded cost compared with the optimal cost.

As we can see, Normalize takes a big risk for the last sharing by using plan (ab)cₙ, for which it gets no reward since it is the last sharing. To address the problem in both Methods discussed so far, next we propose Method ManagedRisk.

We can see from the previous two examples that we need to take some risk, since an Method that takes no risk, such as Greedy, has a poor performance; however, the risk we take needs to be somehow controlled to avoid the situation in Example 4.2. The idea of Method ManagedRisk, at a high level, is that we should take risks, but we should only take a risk on a sharing if the cost of previous sharings are sufficiently high, so that even if the risk we take turns out to be a bad one, the additional cost incurred can be “absorbed” by previous sharings. We introduce the concept of regret to capture this idea

Definition 4.3 Let S₁, S₂, . . . be a sequence of sharings, and let Pᵢ denote the sharing plan for Sᵢ. For each sharing Sᵢ and each subexpression s [symbol] Sᵢ, the regret of s wrt Sᵢ, denoted by rgᵢ(s), is recursively defined as: if the result of s is not produced in any Pⱼ(1≦j<i),

$${rg}_{i} ( s ) = {\sum }_{{s}_{j} \vert j < i , s < {S}_{j}} \frac{C [ {P}_{j} ] - {\sum }_{{s}^{′} ∈ {P}_{j}} {rg}_{j} ( {s}^{′} )}{m - 1} \qquad ( 1 )$$

where m=# join(Sᵢ). Otherwise, rgᵢ(s)=0.

“The result of s is not produced in any Pⱼ(1≦j<i)” means that the result of s is not available when we process sharing Sᵢ, i.e., if we wish to use s in the plan of Sᵢ, we need to pay a cost of c[s]. For example, if s=(ab)c, then this means that no sharing prior to Sᵢ uses subexpression (ab)c or a(bc) in its sharing plan.

Method ManagedRisk is shown in Method 4.4. For each sharing Sᵢ in the sequence and each plan Pᵢⱼ for Sᵢ, it uses a scoring function score(Pᵢⱼ) defined as

$$score [ {P}_{ij} ] = {\sum }_{s ∈ {P}_{i j}} {rg}_{i} ( s ) - C [ {P}_{ij} ] \qquad ( 2 )$$

A sharing plan with large regret and small cost gets a high score. ManagedRisk chooses the plan for sharing Sᵢ with the maximum score among all possible plans for Sᵢ.

The intuition of Method ManagedRisk is as follows. When we process a sharing Sᵢ, if there exists a subexpression s [symbol] Sᵢ which is contained in some of the previous sharings but is never used before, then we give Method ManagedRisk an incentive to use s equivalent to rgᵢ(s). rgᵢ(s) is large if there are many sharings prior to Sᵢ that contain subexpression s. By giving such an incentive, we can avoid the problem in Example 4.1 where a subexpression is never used, because the incentive keeps increasing if we don't use it, and at some point the incentive will be big enough that the subexpression will be used. Even if this is a bad choice, e.g., future sharings will never utilize this subexpression (like the situation in Example 4.2: after Method Normalize uses ab, there is no more sharing to benefit from it), the “damage” it causes will likely be controlled, because the incentive to use this subexpression won't be too large (otherwise it should have been used earlier). These are of course intuitions rather than strict statements, but we will show in Example 4.3 that Method ManagedRisk does avoid the pitfalls in both previous examples.

Note that the regrets of subexpressions used in each Pⱼ (i.e., rgⱼ(s′) in Eq. (1)) are subtracted from rgᵢ(s), because rgⱼ(s′) has already made an impact on choosing plan Pⱼ for sharing Sⱼ, and it should not make another impact on choosing the plan for Sᵢ. Otherwise, the selected plans may have an unbounded cost compared with the optimal cost even if each sharing has at most two joins (a detailed example is shown in the technical report [17]). The factor of 1/(m−1) in Eq. (1) is to avoid the total regret of a sharing plan with many subexpressions being too large.

Example 4.3 Consider the sharing sequence in Example 4.1. For the first 10 sharings, ManagedRisk uses plan a(bcₓ), and pays a cost of 10 for each plan. When it processes the 11th sharing, we have rg₁₁(ab)=100, and the regrets of all other subexpressions are 0. Since

rg₁₁(ab)−C[(ab)c₁₁]=−ε>−C[a(bc₁₁)]=−10,

Method ManagedRisk chooses plan (ab)c₁₁ for this sharing. Note that even if the 11th sharing is the last sharing, which means using (ab)c₁₁ at this point is a bad choice, the cost of ManagedRisk won't be arbitrarily bad because the incentive given to ManagedRisk to use ab is no more than the total cost of the first 10 sharing plans. In this example the cost of ManagedRisk is no more than twice of the optimal cost.

Now consider the sharing sequence in Example 4.2. For 1≦x≦n−1, ManagedRisk uses plan a(bcₓ), incurring a cost of (n−1)ε, and thus rgₙ(ab)=(n−1)ε. For the n th sharing, since the regrets of all other subexpression are 0, we have

rgₙ(ab)−C[(ab)cₙ]<−C[a(bcₙ)]

thus ManagedRisk will use a(bcₙ). In this case, even though subexpression ab is contained in many sharings seen before, ManagedRisk still doesn't use ab for the n th sharing, since the total cost of all previous sharings that contain ab (i.e., rgₙ(ab)) is too small and thus the incentive to use ab is not big enough. ManagedRisk finds the optimal plans for this sharing sequence.

Algorithm 1: Algorithm MANAGEDRISK for the Special Case

| | |
|---|---|
| Input: | a sequence of sharings S₁, . . ., Sₙ. The algorithm |
| | processes each sharing Sᵢ without the information of |
| | sharings after Sᵢ. |

$\begin{matrix}foreach sharing {S}_{i} do \\ \vert \begin{matrix}foreach subexpression p {S}_{i} do \\ \vert compute {rg}_{i} ( p ) using Eq . 1 \\ end \\ enumerate all plans for {S}_{i} ( details available in [ 8 ] ) \\ foreach possible plan {P}_{ij} of {S}_{i} do \\ \vert \begin{matrix}compute C ( {P}_{ij} ) using a dynamic programming \\ method ( details available in [ 8 ] ) \\ score ( {P}_{ij} ) = {\sum }_{p ∈ {P}_{ij}} rg ( p ) - C ( {P}_{ij} ) \end{matrix} \\ end \\ j = arg max score ( {P}_{ij} ) \end{matrix} \\ end \end{matrix}$

The details in [8] are discussed in a paper by the present inventors S. Al-Kiswany, H. Hacigumus, Z. Liu, and J. Sankaranarayanan. Cost Exploration of Data Sharings in the Cloud. In EDBT, pages 601-612, 2013, the content of which is incorporated by reference.

There is a similar notion of regret (also called opportunity loss) in decision theory, which is defined as the additional payoff if a different action is chosen. Although the idea is somewhat similar, there are some key differences. First, decision theory aims to make a choice (such as determining the inventory level of a product) that minimizes the future regret if something goes wrong in future; whereas we do not analyze what can possibly happen in the future (because we don't know or make assumptions on how many sharings we will receive in the future, and what they are). Instead, regret is computed from previous sharings. Second, regret in decision theory is simply the difference in payoff, whereas in our problem the “difference in payoff” cannot be easily computed, because using a different plan for one sharing may affect the “difference in payoff” of many other sharings.

After explaining how Method ManagedRisk works in a special setting, in the next subsection we discuss how to apply Method ManagedRisk in the general case.

We previously made two simplifications: (1) server capacity is considered unlimited; (2) sharings are join-only with no projections or predicates. To cope with the general case, we propose the following extensions of Method ManagedRisk.

When a server has limited capacity such that the desired plan violates the capacity of some servers, we will use the best plan that does not violate any server capacity. If no such plan exists, the sharing is rejected.

When sharings have predicates and projections, we modify the way we compute the score of a sharing plan (Eq. 2). Intuitively, even if the regret of a subexpression s (e.g., a [symbol] b) is high, if a sharing plan P for the current sharing only computes a small subset of the result of s (e.g., s′=a_{a,x<10} [symbol] b), then it is not very helpful to use plan P, since it only has a small chance to be helpful for future sharings that contain a [symbol] b. Consequently, the incentive to use s′ should be smaller than the regret of s. We use percₛ(P) to denote the percentage of tuples computed by subexpression s (possibly with predicates) in plan P, compared with the tuples computed by the same subexpression with no predicate. For a plan P with no predicate, percₛ(P)=100% for all sεP. Otherwise, percₛ(P) may be smaller than 100%, which can be estimated using various existing techniques for selectivity estimation. We modify Eq. 2 as follows:

$$score [ {P}_{ij} ] = {\sum }_{s ∈ {P}_{i j}} {rg}_{i} ( s ) \cdot {perc}_{s} ( {P}_{i j} ) - C ( {P}_{i j} ) \qquad ( 3 )$$

Algorithm 2: Algorithm MANAGEDRISK for the General Case

| | |
|---|---|
| Input: | a sequence of sharings S₁, . . ., Sₙ. The algorithm |
| | processes each sharing Sᵢ without the information of |
| | sharings after Sᵢ. |

$\begin{matrix}foreach sharing {S}_{i} do \\ \vert \begin{matrix}foreach subexpression p {S}_{i} do \\ \vert compute {rg}_{i} ( p ) using Eq . 1 \\ end \\ enumerate all plans for {S}_{i} ( details available in [ 8 ] ) \\ foreach possible plan {P}_{ij} of {S}_{i} do \\ \vert \begin{matrix}compute C ( {P}_{ij} ) using a dynamic programming \\ method ( details available in [ 8 ] ) \\ score ( {P}_{ij} ) = {\sum }_{p ∈ {P}_{ij}} rg ( p ) - {perc}_{p} ( {P}_{ij} ) - C ( {P}_{ij} ) \end{matrix} \\ end \\ sort all plans of {S}_{i} by score foreach possible plan {P}_{ij} of \\ {S}_{i} in descending order of score do \\ \vert \begin{matrix}if {P}_{ij} does not violate server capacity then \\ \vert \begin{matrix}use plan {P}_{ij} for sharing {S}_{i} \\ break \end{matrix} \\ end \end{matrix} \\ end \\ if no feasible plan exists then \\ \vert reject {S}_{i} \\ end \end{matrix} \\ end \end{matrix}$

Calculating the operational cost incurred for the service provider to provide and maintain the view of a sharing is necessary in pricing the sharing. We have shown that a fair costing mechanism is not trivial to obtain.

Next we introduce and explain the fair costing criteria. We use AC (attributed cost) to denote the cost attributed to each sharing, and our goal is to compute a fair AC for each sharing.

(1) For any two identical sharings S₁=S₂, AC(S₁) should be identical with AC(S₂) regardless of the plans chosen for them. Buyers only request data sharings. They do not know or care about what plans the service provider decides to use for their sharings. The service provider may use different plans for the same sharings for several reasons, e.g., server capacity limit, reuse of subexpressions, etc. From the buyers' points of view, in order to be fair, neither should get a lower or higher attributed cost than the other. Sharings S₂ and S₃ are identical. Although they use different plans, i.e., ((ab)c)d for S₂ and (a(bc))d for S₃, they should have the same AC.

(2) For any sharing S, AC(S) should be no more than LPC(S). Since LPC(S) is the lowest cost of S if no other sharing exists (thus there's no reuse of subexpressions), it represents the actual complexity of S. A sharing with a high LPC is inherently expensive in terms of operational cost, and conversely, a sharing with a low LPC is inherently cheap. For global optimization purpose, the service provider may not use the cheapest plan for a sharing, such as the one with predicate “city=Seattle” in Example 1.1, as well as S₄ in Example 5.1. Both of them use plans that have an additional step after some expensive operations. However, from the fairness perspective, buyers of such inherently cheap sharings should not be penalized by the optimization, and thus we propose that AC cannot be more than LPC for a sharing.

(3) For two sharings S₁ and S₂, if Sᵢ's query is contained in S₂'s query (i.e., the tuples retrieved by S₁ are a subset of those retrieved by S₂), and LPC(S₁)≦LPC(S₂), then AC(S₁) should be no more than AC(S₂). Because otherwise, even if a buyer only needs the data of S₁, she can purchase S₂ for a lower price. This is undesirable for the service provider since the service provider pays more but gets a lower revenue.

(4) A sharing plan that has common subexpressions with other sharings, which gives the service provider the opportunity to save cost by reusing subexpressions, should be compensated. In Example 5.1, sharing plans for S₁, S₂, S₄ and S₅ all compute a [symbol] b (denoted by ab), and sharing plans for S₂, S₃, S₄ and S₅ all compute a [symbol] b [symbol] c. These common intermediate results enable the service provider to reuse them in different sharing plans and reduce the cost. Although an intermediate result may not be reused by all sharing plans that contain this intermediate result (e.g., a [symbol] b in S₁'s plan is only reused by S₂), all sharings whose plans contain the intermediate result should be equally rewarded. To capture this idea we introduce the concept of saving of an intermediate result in a sharing plan.

Definition 5.1 (saving of an intermediate result) The saving of an intermediate result r, denoted as saving(r), is the increase of the cost of the global plan if r is no longer reused in the global plan, i.e., all sharings whose plans include r need to compute r and pay the cost of the corresponding subexpressions.

In Example 5.1, there are two intermediate results that are reused, shown in red (ab) and green (abc). If we remove the red arrow, sharing S₂ will need to use a separate subexpression ab, thus the cost of the global plan increases by 4. If we remove the two green arrows, sharing S₃ will need to use subexpressions be and a(bc), and sharing S₄ will need to use subexpressions ab and (ab)c, and the cost of the global plan increases by 28.

We require that part of the saving of an intermediate result should be equally awarded to the sharings whose plans include this intermediate result. Let α be a parameter that indicates at least how much percentage of the saving is awarded to the sharings. Let num(r) denote the number of sharings in the global plan whose plans include r as an intermediate result. We require that

$$A C ( S ) \leq GPC ( S ) - α \cdot {\sum }_{r ∈ S} \frac{saving ( r )}{num ( r )} \qquad ( 4 )$$

where GPC(S) is the cost of S's plan in the global plan. It is calculated by summing up the cost of all edges in S's plan, even if an edge is used by other sharing plans. In Example 5.1, the GPC for the five sharings are 4, 19, 19, 17, 23, respectively.

Parameter a reflects the degree of fairness. α=0 means the savings of the intermediate results are not awarded to the relevant sharings, which is the least fair since a sharing with much commonality with other sharings is treated in the same way as a sharing with no commonality with others. α=1 means that the savings are maximally awarded to the sharings. α=1 is not always achievable because of other fairness requirements, and thus we want to find the maximum possible value of α.

(5) Finally, the sum of AC of all sharings in the global plan should equal the cost of the global plan, i.e., the cost of the global plan should be recovered. This is not directly related to fairness per se, but it is a necessary requirement for a costing function.

The five criteria above are collectively referred to as the fairness criteria. The following lemmas show that these requirements are non-redundant, as well as the condition under which they are achievable.

Lemma 5.1 The five fairness conditions are non-redundant: it is possible to satisfy any four not the fifth.

Lemma 5.2 All five fairness conditions are satisfiable on a global plan GP for a set S of sharings if and only if Σ_{SεS}LPC(S)≧cost(GP).

Algorithm 3: Algorithm FAIRCOST

Input: global plan GP, sharings S₁, . . ., Sₙ
if Σₛ_{ᵢ} LPC(Sᵢ) < cost(GP) then
| return IMPOSSIBLE
end
build a DAG: each node is a sharing (or multiple identical
sharings); each are (Sᵢ, Sⱼ) indicates that Sᵢ is contained in Sⱼ
and LPC(Sᵢ) ≦ LPC(Sⱼ)
foreach intermediate result r in GP do
| calculate saving(r) according to definition 5.1
end
lowα = 0, highα = 1, α = 0.5
while true do
$\vert \begin{matrix}foreach sharing S in increasing order of LPC do \\ \vert \begin{matrix}let {P}_{S} be the predecessors of S in DAG \\ costUB ( S ) = \\ min \{ LPC ( S ) . {min}_{{S}^{′} ∈ {P}_{S}} costUB ( {S}^{′} ) , GPC ( S ) - \\ α \cdot {\sum }_{r ∈ S} \frac{saving ( r ) )}{num ( r )} \} \end{matrix} \\ end \\ if {Σ}_{{S}_{i}} costUB ( {S}_{i} ) = cost ( GP ) then \\ \vert break \\ end \\ else if {Σ}_{{S}_{i}} costUB ( {S}_{i} ) < cost ( GP ) then \\ \vert high α = α - ɛ \\ end \\ else \\ \vert low α = α + ɛ \\ end \\ α = ( low α + high α ) \text{/} 2 \end{matrix}$
end
foreach sharing Sᵢ do
| AC(Sᵢ) = costUB(Sᵢ)
end

Given a specific value of α, we can use the fairness criteria to compute an upper bound cost for each sharing. Note that conditions (1) and (3) make the set of sharings in the global plan a partially ordered set, which means the cost upper bound of a sharing depends on other sharings. Thus we should calculate the upper bound cost of the sharings according to the partial order, i.e., the cost upper bound of a sharing can be determined only after the cost upper bounds of all its predecessors have been determined. If the sum of all cost upper bounds are higher than the cost of the global plan, it means this value of α is feasible.

The Method for computing the maximum value of α, named Method FairCost, is shown in Method 3 (FIG. 3). In FIG. 3, previous queries, the current query, and a cost model is used as inputs. Its input is the global plan and the output is the attributed cost (AC) for each sharing, and thus when a new sharing arrives, the costs of existing sharings may change. This is because if the costs of existing sharings cannot be changed, it is impossible to satisfy the above fairness criteria in a non-trivial way (i.e., α>0). However, the price of each sharing S won't change arbitrarily as it will never exceed LPC(S). The system checks if the LPC is less than the cost of the DG and if not the method exits. Otherwise, method FairCost first builds a DAG to reflect the partial order between sharings. Multiple identical sharings can be represented by a single node in the DAG. We then do a binary search on α. For a specific value of α, we compute the cost upper bounds for the sharings in the order of LPC, which ensures that a sharing is processed after all its predecessors in the DAG have been processed. If the total cost upper bound is more than cost(GP) we search for a higher α value, and if the total cost upper bound is less than cost(GP) we search for a lower α value.

If we run Method FairCost on Example 5.1, it first computes the savings of the intermediate results: savings(ab)=4 and saving(abc)=28. There are 4 sharings whose plans include ab: S₁, S₂, S₄ and S₅, and there are 4 sharings whose plans include abc: S₂, S₃, S₄ and S₅. The maximum possible value of a in this case is 0.8, and the attributed cost of the sharings are: AC(S₁)=3.2, AC(S₂)=12.6, AC(S₃)=12.6, AC(S₄)=5, AC(S₅)=16.6. Their sum is 50, which is exactly the cost of the global plan. A higher value of α would mean that the attributed costs of S₁, S₂, S₃ and S₅ all need to be reduced, which is not possible, because the attributed cost of S₄ cannot be increased as it is the same as its LPC.

The system addresses two problems in building a data market that enables the sharing of dynamic data specified by ad-hoc queries: how to design an online Method for selecting sharing plans, and how to fairly calculate the cost of each sharing plan. We contemplate the ability to change the plan of an existing sharing when a new sharing arrives, and how it effects the strategies for selecting sharing plans and costing the sharings; whether it is beneficial to create and maintain views that do not belong to any existing sharing plan (so that future sharings may reuse them), rather than reusing only those views created by existing sharing plans, and how to determine which views to create. The system can be summarized as follows.
We use an online process called Method ManagedRisk, that selects sharing plans for dynamic data sharings in a cloud data market. Method ManagedRisk avoids the pitfalls in the baseline processes and avoids making bad decisions observed in the baseline processes.
The system is unique on fair costing of data sharing in a data market. We propose fairness criteria which represent fairness as a value between 0 and 1, and a method to find a costing function that maximizes the fairness.
Our experiments verified the effectiveness and efficiency of the proposed approaches.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method for dynamic data sharing in a cloud data market, comprising:
generating n sharing plans;
determining a cost of a global plan as cost(GP) with the n sharing plans P₁, . . . , Pₙ with an attributed cost to Pᵢ is AC(Pᵢ);
determining a total cost of sharing plans as equal the cost of the global plan so
$${\sum }_{i = 1}^{n} A C ( {P}_{i} ) = cost ( GP )$$
wherein cost(GP) is distributed to each AC(Pᵢ) in accordance with a set of fairness criteria of fair costing for data sharings in a data market, wherein the fairness criteria includes:
for any two identical sharings S1=S2, AC(S1) should be identical with AC(S2) regardless of the plans;
for any sharing S, AC(S) should be no more than LPC(S);
for two sharings S1 and S2, if S1's query is contained in S2's query and LPC(S1)≦LPC(S2), then AC(S1) should be no more than AC(S2);
a sharing that has common subexpressions with other sharings, is compensated; and
a sum of all sharings in the global plan equals the cost of the global plan to recover cost of the global plan; and
generating costing data sharings in a data market that maximizes fairness.

2. The method of claim 1, comprising generating an attributed cost (AC) for each sharing with a new sharing based on a global plan and updating costs of existing sharings.

3. The method of claim 1, wherein a price of each sharing S does not exceed LPC(S).

4. The method of claim 1, comprising building a directed acyclic graph (DAG) to reflect a partial order between sharings.

5. The method of claim 1, wherein multiple identical sharings are represented by a single node in the DAG.

6. The method of claim 1, comprising performing a binary search on α, wherein α reflects the degree of fairness and α=0 means savings of intermediate results are not awarded to the sharings.

7. The method of claim 1, comprising determining cost upper bounds for the sharings in the order of LPC for a specific value of a to ensure that a sharing is processed after its predecessors in the DAG have been processed.

8. The method of claim 7, comprising searching for a higher α value if a total cost upper bound is more than cost(GP), and searching for a lower α value if the total cost upper bound is less than cost(GP).

9. The method of claim 1, comprising requiring
$$A C ( S ) \leq GPC ( S ) - α \cdot {\sum }_{r ∈ S} \frac{saving ( r )}{num ( r )}$$
where GPC(S) is the cost of S's plan in the global plan and calculated by summing up the cost of all edges in S's plan, even if an edge is used by other sharing plans and num(r) denote the number of sharings in the global plan whose plans include r as an intermediate result.

10. The method of claim 1, comprising selecting the plan with the smallest normalized cost before determining the cost of the plans.

11. A method for dynamic data sharing in a cloud data market, comprising:
a processor;
a plurality of data store coupled to the processor containing the data to be shared; and
computer code executed by the processor to:
generate n sharing plans;
determine a cost of a global plan as cost(GP) with n sharing plans P₁, . . . , Pₙ where an attributed cost to Pᵢ is AC(Pᵢ);
determine a total cost of sharing plans as equal the cost of the global plan so
$${\sum }_{i = 1}^{n} A C ( {P}_{i} ) = cost ( GP )$$
wherein cost(GP) is distributed to each AC(Pᵢ) in accordance with a set of fairness criteria of fair costing for data sharings in a data market, wherein the fairness criteria includes:
for any two identical sharings S1=S2, AC(S1) should be identical with AC(S2) regardless of the plans;
for any sharing S, AC(S) should be no more than LPC(S);
for two sharings S1 and S2, if S1's query is contained in S2's query and LPC(S1)≦LPC(S2), then AC(S1) should be no more than AC(S2);
a sharing that has common subexpressions with other sharings, is compensated; and
a sum of all sharings in the global plan equals the cost of the global plan to recover cost of the global plan; and
generate costing data sharings in a data market that maximizes fairness.

12. The system of claim 11, comprising code for generating an attributed cost (AC) for each sharing with a new sharing based on a global plan and updating costs of existing sharings.

13. The system of claim 11, wherein a price of each sharing S does not exceed LPC(S).

14. The system of claim 11, comprising code for building a directed acyclic graph (DAG) to reflect a partial order between sharings.

15. The system of claim 11, wherein multiple identical sharings are represented by a single node in the DAG.

16. The system of claim 11, comprising code for performing a binary search on α, wherein α reflects the degree of fairness and α=0 means savings of intermediate results are not awarded to the sharings.

17. The system of claim 11, comprising code for determining cost upper bounds for the sharings in the order of LPC for a specific value of a to ensure that a sharing is processed after its predecessors in the DAG have been processed.

18. The system of claim 17, comprising code for searching for a higher α value if a total cost upper bound is more than cost(GP), and searching for a lower α value if the total cost upper bound is less than cost(GP).

19. The system of claim 11, comprising code for requiring
$$A C ( S ) \leq GPC ( S ) - α \cdot {\sum }_{r ∈ S} \frac{saving ( r )}{num ( r )}$$
where GPC(S) is the cost of S's plan in the global plan and calculated by summing up the cost of all edges in S's plan, even if an edge is used by other sharing plans and num(r) denote the number of sharings in the global plan whose plans include r as an intermediate result.

20. The system of claim 11, comprising code for selecting the plan with the smallest normalized cost.
